(19) United States
(12) Patent Application Publication
(10) Pub. No.: US 2024/0373776 A1
(43) Pub. Date: Nov. 14, 2024

(54) POSITION CONTROL OF A SEGMENTED AGRICULTURAL WORK ASSEMBLY

(71) Applicant: CNH Industrial America LLC, New Holland, PA (US)

(72) Inventor: David M. DeChristopher, II, Ephrata, PA (US)

(21) Appl. No.: 18/681,842

(22) PCT Filed: Aug. 4, 2022
(86) PCT No.: PCT/US2022/039412

§ 371 Date: Feb. 6, 2024

Related U.S. Application Data
(60) Provisional application No. 63/230,294, filed on Aug. 6, 2021.

(51) Int. Cl. A01B 73/04

(52) U.S. Cl. CPC A01B 73/044

(57) ABSTRACT

An agricultural work assembly of an agricultural vehicle includes: a center section frame assembly: a wing section frame assembly: a linkage assembly including a first link, a second link, and a pivot connection pivotably connecting first link and second link together, the first link including a first segment and a second segment rigidly connected to one another and forming a pivot portion therebetween, the first segment forming the pivot connection with the second link, the first link being pivotably connected to the center section frame assembly or the wing section frame assembly at the pivot portion, the second link being pivotably connected to the other one of, relative to the first link, the center section frame assembly and the wing section frame assembly; and an actuator pivotably connected to the second segment and thereby configured for positioning the wing section frame assembly relative to the center section frame assembly.

### FIELD OF THE INVENTION

The present invention pertains to an agricultural vehicle, and, more specifically, to a work assembly of the agricultural vehicle

### BACKGROUND OF THE INVENTION

Agricultural vehicles are employed to perform agricultural work efficiently. Such vehicles include, but are not limited to, agricultural harvesters, windrowers, sprayers, and tractors. Agricultural vehicles often include work assemblies affixed or otherwise attached thereto. For example, agricultural harvesters and windrowers can include headers (also referred to as heads), sprayers can include booms attached thereto, and tractors can include implements attached thereto, such implements including, for example, a pull-type forage harvester.

Considering one example of agricultural vehicles, the agricultural harvester known as a “combine” is historically termed such because it combines multiple harvesting functions with a single harvesting unit, such as cutting, threshing, separating, and cleaning. A combine includes a header which removes the crop from a field, and a feeder housing which transports the crop matter into a threshing rotor. The threshing rotor rotates within a perforated housing, which may be in the form of adjustable concaves, and performs a threshing operation on the crop to remove the grain. Once the grain is threshed it falls through perforations in the concaves onto a grain pan. From the grain pan the grain is cleaned using a cleaning system, and is then transported to a grain tank onboard the combine. A cleaning fan blows air through the sieves to discharge chaff and other debris toward the rear of the combine. Non-grain crop material such as straw from the threshing section proceeds through a residue handling system, which may utilize a straw chopper to process the non-grain material and direct it out the rear of the combine. When the grain tank becomes full, the combine is positioned adjacent a vehicle into which the grain is to be unloaded, such as a semi-trailer, gravity box, straight truck, or the like, and an unloading system on the combine is actuated to transfer the grain into the vehicle.

More particularly, a rotary threshing or separating system includes one or more rotors that can extend axially (front to rear) or transversely (side to side) within the body of the combine, and which are partially or fully surrounded by perforated concaves. The crop material is threshed and separated by the rotation of the rotor within the concaves. Coarser non-grain crop material such as stalks and leaves pass through a straw beater to remove any remaining grains, and then are transported to the rear of the combine and discharged back to the field. The separated grain, together with some finer non-grain crop material such as chaff, dust, straw, and other crop residue are discharged through the concaves and fall onto a grain pan where they are transported to a cleaning system. Alternatively, the grain and finer non-grain crop material may also fall directly onto the cleaning system itself.

A cleaning system further separates the grain from non-grain crop material, and typically includes a fan directing an airflow stream upwardly and rearwardly through vertically arranged sieves which oscillate in a fore and aft manner. The airflow stream lifts and carries the lighter non-grain crop material towards the rear end of the combine for discharge to the field. Clean grain, being heavier, and larger pieces of non-grain crop material, which are not carried away by the airflow stream, fall onto a surface of an upper sieve (also known as a chaffer sieve), where some or all of the clean grain passes through to a lower sieve (also known as a cleaning sieve). Grain and non-grain crop material remaining on the upper and lower sieves are physically separated by the reciprocating action of the sieves as the material moves rearwardly. Any grain and/or non-grain crop material which passes through the upper sieve, but does not pass through the lower sieve, is directed to a tailings pan. Grain falling through the lower sieve lands on a bottom pan of the cleaning system, where it is conveyed forwardly toward a clean grain auger. The clean grain auger conveys the grain to a grain elevator, which transports the grain upwards to a grain tank for temporary storage. The grain accumulates to the point where the grain tank is full and is discharged to an adjacent vehicle such as a semi trailer, gravity box, straight truck or the like by an unloading system on the combine that is actuated to transfer grain into the vehicle.

The work assemblies (including headers, attachments, or implements) of agricultural vehicles (such as those identified above) can be articulated, which can also be referred to as segmented. For example, a combine can include a header that is segmented into three segments or sections (these terms being used interchangeably), namely, a center section joined laterally by wing sections. An advantage of segmenting a header in this manner includes facilitating traversal over uneven terrain. However, the wings need to be accurately and efficiently positioned relative to the center section.

Known in the art is a combine with a segmented header which includes a respective hydraulic cylinder in conjunction with the center and wing sections. The hydraulic cylinder serves to controllably position the wing section relative to the center section. More specifically, the center section includes a center section frame assembly, and each wing section includes a wing section frame assembly. Each of these frame assemblies includes an upper frame and a lower frame spaced apart from the upper frame, the upper frame and the lower frame extending substantially transverse to a direction of travel of the combine. The hydraulic cylinder is positioned between and connected to the upper frame of the center section frame assembly and the upper frame of a respective wing section frame assembly. While this positioning of the hydraulic cylinder has served well, it has been found that the positioning of the hydraulic cylinder can be improved, so as to enhance the mechanical advantage that the hydraulic cylinder can provide relative to the positioning of the wing sections relative to the center section.

What is needed in the art is an improved way to control positioning of the wings relative to the center section of an agricultural work assembly of an agricultural vehicle.

### SUMMARY OF THE INVENTION

The present invention provides an improved way to control positioning of the wings relative to the center section of an agricultural work assembly of an agricultural vehicle, by providing a well-positioned actuator connected to a linkage assembly between center and wing sections.

The invention in one form is directed to an agricultural work assembly of an agricultural vehicle, including: a center section frame assembly; a wing section frame assembly; a linkage assembly including a first link, a second link, and a pivot connection pivotably connecting the first link and the second link together, the first link including a first segment and a second segment rigidly connected to one another and forming a pivot portion therebetween, the first segment forming the pivot connection with the second link, the first link being pivotably connected to one of the center section frame assembly and the wing section frame assembly at the pivot portion, the second link being pivotably connected to the other one of, relative to the first link, the center section frame assembly and the wing section frame assembly; and an actuator pivotably connected to the second segment and thereby configured for positioning the wing section frame assembly relative to the center section frame assembly.

The invention in another form is directed to an agricultural work assembly of an agricultural vehicle, the work assembly including: a center section frame assembly; a wing section frame assembly; a linkage assembly including a first link, a second link, and a pivot connection pivotably connecting the first link and the second link together, the first link and the second link being pivotably connected respectively to the center section frame assembly and the wing section frame assembly; and an actuator configured for positioning the wing section frame assembly relative to the center section frame assembly, the actuator including a first end and a second end, the first end being pivotably connected to one of the center section frame assembly and the wing section frame assembly and spaced apart from both the first link and second link, the second end being pivotably connected to the pivot connection.

The invention in yet another form is directed to a method of using an agricultural vehicle including an agricultural work assembly, the method including the steps of: providing an agricultural work assembly including: a center section frame assembly; a wing section frame assembly; a linkage assembly including a first link, a second link, and a pivot connection pivotably connecting the first link and the second link together, the first link including a first segment and a second segment rigidly connected to one another and forming a pivot portion therebetween, the first segment forming the pivot connection with the second link, the first link being pivotably connected to one of the center section frame assembly and the wing section frame assembly at the pivot portion, the second link being pivotably connected to the other one of, relative to the first link, the center section frame assembly and the wing section frame assembly; and an actuator pivotably connected to the second segment; and positioning, using the actuator and by way of the actuator being pivotably connected to the second segment, the wing section frame assembly relative to the center section frame assembly.

An advantage of the present invention is that it provides a way for controllably positioning-namely, raising and lowering at least portions of—the wing sections relative to the center section.

Another advantage of the present invention is that it provides a mechanical advantage with respect to positioning of the wings.

Yet another advantage of the present invention is that it provides an elegantly simple design, thereby simplifying manufacture and replacement of associated parts.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a side view of an exemplary embodiment of an agricultural vehicle, the agricultural vehicle comprising a header assembly, in accordance with an exemplary embodiment of the present invention;

FIG. 2 illustrates a perspective view of one embodiment of the header assembly of FIG. 1 with portions broken away, the header assembly including a linkage assembly and an actuator, in accordance with an exemplary embodiment of the present invention;

FIG. 3 illustrates a front view of the header assembly of FIG. 2, with the actuator in a retracted position;

FIG. 4 illustrates a front view of the header assembly of FIG. 2, with the actuator in an extended position;

FIG. 5 illustrates a front view of another embodiment of the header assembly of the agricultural vehicle of FIG. 1, with portions broken away, the header assembly including a linkage assembly and an actuator, with the actuator being in the retracted position, in accordance with an exemplary embodiment of the present invention;

FIG. 6 illustrates a front view of the header assembly of FIG. 5, with the actuator being in the extended position;

FIG. 7 illustrates a front view of yet another embodiment of the header assembly of the agricultural vehicle of FIG. 1, with portions broken away, the header assembly including a linkage assembly and an actuator, with the actuator being in the retracted position, in accordance with an exemplary embodiment of the present invention;

FIG. 8 illustrates a front view of the header assembly of FIG. 7, with the actuator being in the extended position;

FIG. 9 illustrates a front view of yet another embodiment of the header assembly of the agricultural vehicle of FIG. 1, with portions broken away, the header assembly including a linkage assembly and an actuator, with the actuator being in the retracted position, in accordance with an exemplary embodiment of the present invention;

FIG. 10 illustrates a front view of the header assembly of FIG. 9, with the actuator being in the extended position;

FIG. 11 illustrates a front view of yet another embodiment of the header assembly of the agricultural vehicle of FIG. 1, with portions broken away, the header assembly including a linkage assembly and an actuator, with the actuator being in the retracted position, in accordance with an exemplary embodiment of the present invention;

FIG. 12 illustrates a front view of the header assembly of FIG. 11, with the actuator being in the extended position; and

FIG. 13 illustrates a flow diagram showing a method of using an agricultural vehicle including an agricultural work assembly, in accordance with an exemplary embodiment of the present invention.

### DETAILED DESCRIPTION OF THE INVENTION

The present invention applies to various types of agricultural vehicles and work assemblies of such agricultural vehicles. Such agricultural vehicles include, but are not limited to, agricultural harvesters, windrowers, sprayers, and tractors. Such work assemblies include attachments or implements of these agricultural vehicles, including, but not limited to, headers of agricultural harvesters and windrowers, booms (for applying an agricultural product) of sprayers, and implements of tractors, such as a pull-type forage harvester. The following discusses an agricultural harvester, known as a combine, according to an exemplary embodiment of the present invention.

Regarding agricultural harvesters, the terms “grain”, “straw” and “tailings” are used principally throughout this specification for convenience but it is to be understood that these terms are not intended to be limiting. Thus “grain” refers to that part of the crop material which is threshed and separated from the discardable part of the crop material, which is referred to as non-grain crop material, MOG or straw. Incompletely threshed crop material is referred to as “tailings”. Also, the terms “forward”, “rearward”, “left” and “right”, when used in connection with the agricultural harvester and/or components thereof are usually determined with reference to the direction of forward operative travel of the harvester, but again, they should not be construed as limiting. The terms “longitudinal” and “transverse” are determined with reference to the fore-and-aft direction of the agricultural harvester and are equally not to be construed as limiting. The terms “downstream” and “upstream” are determined with reference to the intended direction of crop material flow during operation, with “downstream” being analogous to “rearward” and “upstream” being analogous to “forward.”

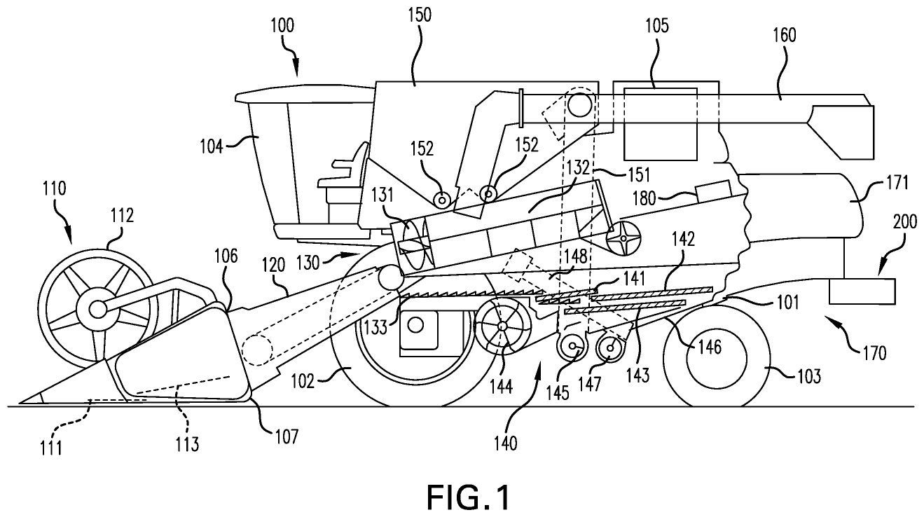

Referring now to the drawings, and more particularly to FIG. 1, there is shown an embodiment of an agricultural harvester 100 in the form of a combine which generally includes a chassis 101, ground engaging wheels 102 and 103, header 110, feeder housing 120, operator cab 104, threshing and separating system 130, cleaning system 140, grain tank 150, and unloading conveyance 160. Front wheels 102 are larger flotation type wheels, and rear wheels 103 are smaller steerable wheels. Motive force is selectively applied to front wheels 102 through a power plant in the form of a diesel engine 105 and a transmission (not shown). Although combine 100 is shown as including wheels, is also to be understood that combine 100 may include tracks, such as full tracks or half tracks.

Header 110 is mounted to the front of combine 100 and includes a cutterbar 111 (shown schematically) for severing crops from a field during forward motion of combine 100. A rotatable reel 112 feeds the crop into header 110, and side drapers 113 (shown schematically) feed the severed crop laterally inwardly from each side toward center drapers and onward to feeder housing 120. Feeder housing 120 conveys the cut crop to threshing and separating system 130, and is selectively vertically movable using appropriate actuators, such as hydraulic cylinders (not shown). Header 110 is a segmented header (as referenced above) and thus includes a center section 106 and two wing sections 107 (each of which can be referred to as a wing 107, though only left wing 107 is visible in FIG. 1), one wing 107 being on each side of center section 106 and substantially mirroring one another. From the operator's vantage point within cab 104, center section 106 is directly in front of the operator and positioned in front of feeder housing 120; it is understood that center section 106 is in the background of FIG. 1. Left wing 107 is positioned to the operator's left (the left side of left wing 107 is visible in FIG. 1) and thus is coupled with the left side of center section 106. Correspondingly, right wing 107 is positioned to the operator's right and is thus coupled with the right side of center section 106. Each section 106, 107 can be substantially similar in size in terms of their transverse extent, though wings 107 in other embodiments can be shorter or longer than center section in their transverse extent. This relative positioning and sizing of center section 106 and wing sections 107, together with what sorts of structure these sections 106, 107 include, are well-known in the art; thus, only portions thereof will be shown in the remaining figures, with the focus being on the frame assemblies of these sections 106, 107 and, more particularly, their coupling together in accordance with the present invention.

Threshing and separating system 130 is of the axial-flow type, and generally includes a threshing rotor 131 at least partially enclosed by a rotor cage and rotatable within a corresponding perforated concave 132. The cut crops are threshed and separated by the rotation of rotor 131 within concave 132, and larger elements, such as stalks, leaves and the like are discharged from the rear of combine 100. Smaller elements of crop material including grain and non-grain crop material, including particles lighter than grain, such as chaff, dust and straw, are discharged through perforations of concave 132. Threshing and separating system 130 can also be a different type of system, such as a system with a transverse rotor rather than an axial rotor, etc.

Grain which has been separated by the threshing and separating assembly 130 falls onto a grain pan 133 and is conveyed toward cleaning system 140. Cleaning system 140 may include an optional pre-cleaning sieve 141, an upper sieve 142 (also known as a chaffer sieve or sieve assembly), a lower sieve 143 (also known as a cleaning sieve), and a cleaning fan 144. Grain on sieves 141, 142 and 143 is subjected to a cleaning action by fan 144 which provides an air flow through the sieves to remove chaff and other impurities such as dust from the grain by making this material airborne for discharge from a straw hood 171 of a residue management system 170 of combine 100. Optionally, the chaff and/or straw can proceed through a chopper 180 to be further processed into even smaller particles before discharge out of the combine 100 by a spreader assembly 200. It should be appreciated that the “chopper” 180 referenced herein, which may include knives, may also be what is typically referred to as a “beater”, which may include flails, or other construction and that the term “chopper” as used herein refers to any construction which can reduce the particle size of entering crop material by various actions including chopping, flailing, etc. Grain pan 133 and pre-cleaning sieve 141 oscillate in a fore-to-aft manner to transport the grain and finer non-grain crop material to the upper surface of upper sieve 142. Upper sieve 142 and lower sieve 143 are vertically arranged relative to each other, and likewise oscillate in a fore-to-aft manner to spread the grain across sieves 142, 143, while permitting the passage of cleaned grain by gravity through the openings of sieves 142, 143.

Clean grain falls to a clean grain auger 145 positioned crosswise below and toward the front of lower sieve 143. Clean grain auger 145 receives clean grain from each sieve 142, 143 and from a bottom pan 146 of cleaning system 140. Clean grain auger 145 conveys the clean grain laterally to a generally vertically arranged grain elevator 151 for transport to grain tank 150. Tailings from cleaning system 140 fall to a tailings auger trough 147. The tailings are transported via tailings auger 147 and return auger 148 to the upstream end of cleaning system 140 for repeated cleaning action. A pair of grain tank augers 152 at the bottom of grain tank 150 convey the clean grain laterally within grain tank 150 to unloader 160 for discharge from combine 100.

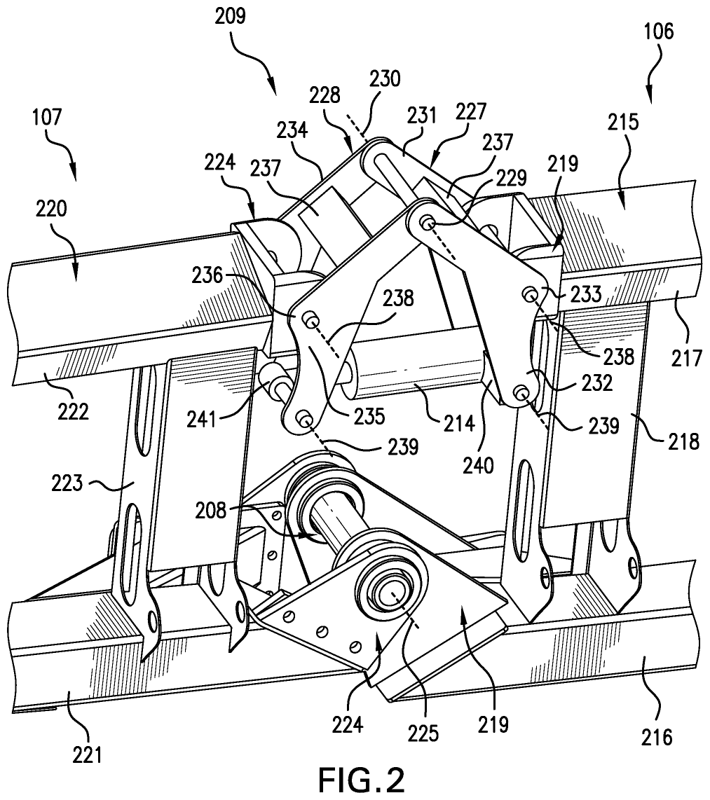

Referring now to FIGS. 2-4, there is shown a portion of work assembly 110—namely, header 110—of combine 100. Header 110 includes center section 106, wing section 107, a hinge 208, a linkage assembly 209, and an actuator 214. Center section 106 is shown with portions broken away, coupled with right wing 107; it will be appreciated that what is shown in FIG. 2 is mirrored on the other side of center section 106, together with left wing 107, and the coupling of center section 106 and left wing 107 together (all remaining figures showing structure are similarly presented for the same reasoning). Center section 106 includes a center section frame assembly 215, which includes a lower frame 216, an upper frame 217, and a plurality of upright supports 218. Lower frame 216 and upper frame 217 can be substantially parallel to one another. Each of lower frame 216 and upper frame 217 can include on their respective right sides pivot connector 219, each of which can be formed as two lugs with through holes for accommodating a pivot pin therethrough (as shown). Upright supports 218 (only one such support 218 is shown in the figures, but it will appreciated that additional supports 218 can be included, as with supports 223 of wing section 107) are spaced apart from one another along the length of lower and upper frames 216, 217, connect lower and upper frames 216, 217 together, and support upper frame 217. Upper frame 217 can be sloped downwards aft-to-fore to enable better visibility for the operator from cab 104.

Similarly, wing section 107 includes a wing section frame assembly 220, which includes a lower frame 221, an upper frame 222, and a plurality of upright supports 223. Lower frame 221 and upper frame 222 can be substantially parallel to one another, or, alternatively, can converge relatively toward one another toward their outboard ends (furthest away from central section 106). Each of lower frame 221 and upper frame 222 can include on their respective left sides pivot connector 224, each of which can be formed as two lugs with through holes for accommodating a pivot pin therethrough (as shown). Upright supports 223 are spaced apart from one another along the length of lower and upper frames 221, 222, connect lower and upper frames 221, 222 together, and support upper frame 222. Wing section frame assembly 220, as well as center section frame assembly 215, can be made of steel or any suitable material. As with center section frame assembly 215, upper frame 222 can be sloped downwards aft-to-fore to enable better visibility for the operator from cab 104.

Hinge 208 pivotably couples center section frame assembly 215 and wing section frame assembly 220 together and can be located at the lower portion of central and wing frame assemblies 215, 220; though hinge 208 pivotably connecting assemblies 215 and 220 together is described and shown herein as being at the lower portion of assemblies 215, 220, the hinge can be located at any other suitable position, such as the middle portion of assemblies 215, 220, the top portion, some other intermediate portion, or any combination of positions. Hinge 208 includes structures already mentioned. That is, hinge 208 includes pivot connector 219 of lower frame 216 of center section 106 and pivot connector 224 of lower frame 221 of wing section 107, as well as the pivot pin extending through these pivot connectors 219, 224, and any associated structure, such as any suitable locking mechanism to secure pivot pin to pivot connectors, such as cotter pins, weldments, bearings, sleeves, or the like. Hinge 208 enables center section frame assembly 215 and wing section frame assembly 220 to pivot relative to one another about axis 225 in both directions.

Linkage assembly 209 can include a plurality of links and can further couple center and wing section frame assemblies 215, 220 together. Linkage assembly 209 can be located at the upper portion of central and wing section frame assemblies 215, 220; though linkage assembly 209 pivotably connecting assemblies 215 and 220 together is described and shown herein as being at the upper portion of assemblies 215, 220, the linkage assembly can be located at any other suitable position, such as the middle portion of assemblies 215, 220, the top portion, some other intermediate portion, or any combination of positions. According to an exemplary embodiment of linkage assembly 209, linkage assembly 209 can be a torque transfer linkage assembly (such that linkage assembly 209 can be also referred to herein as torque transfer linkage assembly or “TTL assembly”); though it can be appreciated that linkage assembly 209 (and any of the other numbered linkage assemblies herein) does not necessarily have to be a torque transfer linkage assembly in accordance with the present invention, the embodiments of the present invention discussed herein provide the linkage assembly as a torque transfer linkage assembly. Torque transfer linkage assembly 209 provides for improved (relative to hinge 208 alone) structural torsional resistance between center and wing section frame assemblies 215, 220 (which can be distinguished from torsional stiffness about hinge 208). First, TTL assembly 209 inhibits wing upper frame 222 from moving forward relative to the center section upper frame 217 (that is, forward translation in a horizontal plane). Second, TTL assembly 209 inhibits wing section upper frame 222 from rotating relative to center section upper frame 217 about a vertical axis of rotation. Third, TTL assembly 209 inhibits wing section upper frame 222 from rotating relative to center section upper frame 217 about a horizontal axis of rotation extending in the transverse direction (that is, laterally). The structure of TTL assembly 209 can be made of steel, or any suitable polymer, or any other suitable material.

Torque transfer linkage assembly 209, according to an exemplary embodiment of the present invention, includes a first link 227, a second link 228, and a first pivot connection 229 pivotably connecting the first link 227 and the second link 228 together. First pivot connection 229 can include through-holes through respective ends of first and second links 227, 228, a pivot pin extending through the through-holes, and any suitable locking mechanism for securing the pivot pin to first and second links, such as cotter pins, weldments, bearings, sleeves, or the like. First and second links 227, 228 can rotate in either direction about axis of rotation 230 associated with first pivot connection 229. First link 227 includes a first segment 231 and a second segment 232 rigidly connected to one another and forming a pivot portion 233 therebetween (that is, where first and second segments 231, 232 join one another), which can be formed as an angle or straight. Pivot portion 233 (which can be referred to as first pivot portion 233) is a portion of first link 227 which is located between ends of first link 227, includes the coming together of first and second segments 231, 232, and provides a pivot connection with pivot connector 219. Second link 228 includes a first segment 234 and a second segment 235 rigidly connected to one another and forming a pivot portion 236 therebetween, which can be formed as an angle or straight. Like pivot portion 233, pivot portion 236 (which can be referred to as second pivot portion 236) is a portion of second link 228 which is located between ends of second link 228, includes the coming together of first and second segments 234, 235, and provides a pivot connection with pivot connector 224. Further, first segment 231 of first link 227 and first segment 234 of second link 228 form first pivot connection 229 therebetween. First and second links 227, 228, as seen in FIG. 2, each includes two side walls substantially parallel to one another with a support 237 extending between these two side walls. First link 227 is pivotably connected to center section frame assembly 215 or wing section frame assembly 220 at first pivot portion 233, FIG. 2 showing first link 227 being pivotably connected to center section frame assembly 215. Correspondingly, second 228 link is pivotably connected to the other one of, relative to first link 227, center section frame assembly 215 or wing section frame assembly 220 at second pivot portion 236, FIG. 2 showing second link 228 being pivotably connected to wing section frame assembly 220. First and second links 227, 228 at respective ones of first and second pivot portions 233, 236 include through-holes positioned adjacent to and aligned with through-holes in pivot connectors 219, 224 of upper frames 217, 222 of central section frame assembly 215 and wing section frame assembly 220, with a respective pivot pin extending therethrough, these pivot connections 219, 224 also including any suitable securing mechanism for securing the respective pivot pin to first and second links 227, 228 and these pivot connectors 219, 224, such as cotter pins, weldments, bearings, sleeves, or the like (such as a weldment between first and second links 227, 228 and the respective pivot pins). First and second links 227, 228 can rotate in either direction about respective axes of rotation 238 relative to pivot connectors 219, 224 of upper frames 217, 222. First and second links 227, 228, in their respective second segments 232, 235, include through-holes with a pivot pin extending therethrough, together with any suitable securing mechanism for securing the pivot pin to first and second links 227, 228, such as cotter pins, weldments, bearings, sleeves, or the like (such as a weldment between first and second links 227, 228 and the respective pivot pins). First and second links 227, 228 can rotate in either direction about respective axes of rotation 239 relative to actuator 214. First and second links 227, 228 can be formed, for example, by molding, casting, metal forming, extrusion, and/or welding parts to one another, or any other suitable method.

Actuator 214 (as with all references herein to an actuator in accordance with exemplary embodiments of the present invention) can be any suitable actuator configured to move first and second links 227, 228 relative to one another. By way of example and not limitation, actuator 214 can be a fluid actuator (such as a hydraulic actuator or a pneumatic actuator), an electric actuator (such as an electromechanical actuator or an electrohydraulic actuator), an electronic actuator, and/or a mechanical actuator. Herein, actuator 214 is discussed as being formed as a fluid actuator, more specifically, as a hydraulic actuator assembly, according to an exemplary embodiment of the present invention (actuator 214 can be referred to herein, alternatively, as actuator, fluid actuator, hydraulic cylinder, or hydraulic cylinder assembly). Such a hydraulic cylinder assembly 214 can include a cylinder (which can also be referred to as a barrel), a piston, and a rod, can be single-acting or double-acting, can be in a hydraulic closed circuit or an open circuit, and can use hydraulic oil as its working fluid. Such hydraulic cylinder assemblies 214 are well-known in the art. Hydraulic cylinder assembly 214 can use the hydraulic system of header 110, which itself uses the hydraulic system of combine 100 (considered apart from header 110). Hydraulic systems of header 110 and combine 100 (considered apart from header 110) are well-known in the art. For example, combine 100 (considered apart from header 110) can include an engine 105, a fluid reservoir, a pump, a hydraulic motor, and fluid lines communicating fluid (for example, hydraulic oil) between various components and to a coupler, such as on feeder housing 120. This coupler can mate with a coupler of header 110, so that a plurality of hydraulic lines of combine 100 (considered apart from header 110) can fluidly communicate with a plurality of hydraulic lines of header 110. The hydraulic system of header 110 can further include, for example, such hydraulic lines, a hydraulic motor, and associated valving. For example, though not specifically shown and/or labeled in the figures, each hydraulic cylinder 214 can be associated with a respective one flow valve, which can meter the proper amount of hydraulic oil into and out of the cylinder of the respective hydraulic cylinder assembly 214; alternatively, a single flow valve can be assigned not to only one hydraulic cylinder assembly (as mentioned) but to a group of hydraulic cylinder assemblies 214, including two or more such hydraulic cylinder assemblies 214. Such valving is well-known in the art. Hydraulic cylinder assembly 214 can be formed of any suitable material by any suitable way.

As FIG. 2 shows, actuator 214 extends between distal ends of second segments 232, 235 of first link 227 and second link 228. Actuator 214 is pivotably connected to these second segments 232, 235 and is thereby configured for actively positioning wing section frame assembly 220 relative to center section frame assembly 215. Actuator 214 includes a first end 240 and a second end 241. First end 240 is located on the cylinder of actuator 214, and second end 241 is on the rod of actuator 214, as shown (it can be appreciated that the positioning of actuator 2114 relative to first and second links 227, 228 can be reversed, according to another embodiment of the present invention). Thus, first end 240 is pivotably connected to second segment 232 of first link 227, and second end 241 is pivotably connected to second segment 235 of second link 228. First and second ends 240, 241 are pivotably connected as mentioned by way of the aforementioned pivot pins extending through the through-holes of second segments 232, 235 of first and second links 227, 228 and through corresponding holes formed at first and second ends 240, 241 of actuator 214, such holes in these ends 240, 241 being formed with any suitable materials and by any suitable ways. As shown in FIGS. 2-4, actuator 214 can be positioned below first pivot connection 229, according to an exemplary embodiment of the present invention. Further, according to the present invention, the actuator (such as actuator 214) can be positioned at any suitable location, such as at or near lower frames 216, 221, at or near upper frames 217, 222, or at any position therebetween, and can be above, below, to one or both sides of, or any combination thereof, the hinge (such as hinge 208).

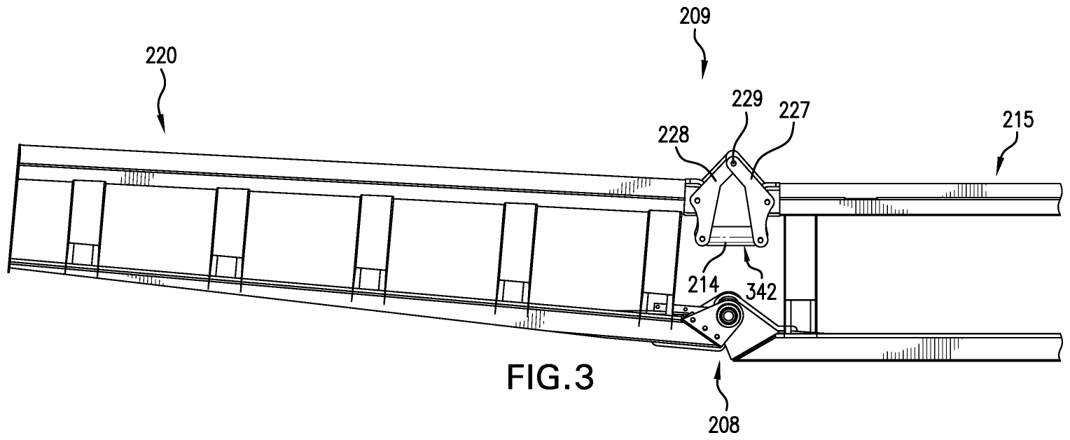

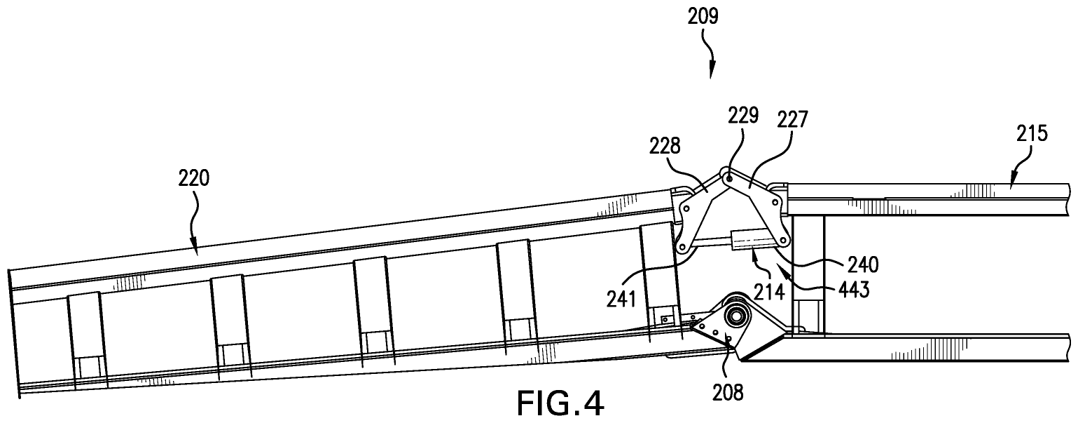

With the inflow and outflow of hydraulic oil in the cylinder of hydraulic cylinder assembly 214, the piston moves within the cylinder, causing the rod (shown in FIG. 2) to move proportionally between a retracted position and an extended position (each such position refers to a fully retracted and fully extended position). In FIG. 2, the rod is shown approximately midway between the retracted and extended positions, such that wing 107 is generally level with center section 106. In FIG. 3, actuator 214 is in the retracted position 342, which causes wing section frame assembly 220 to be in its up-most position relative to center section frame assembly 215. In FIG. 4, actuator 214 is in the extended position 443, which causes wing section frame assembly 220 to be in its down-most position relative to center section frame assembly 215. With first and second links 227, 228 being shaped, sized, and positioned, and actuator 214 being shaped, sized, and positioned, as shown in FIGS. 2-4, a mechanical advantage can be attained. That is, the stroke of actuator 214 of the present invention can be lengthened, as compared to a scenario in which the actuator 214 is pivotably attached to and positioned between upper frames 217, 222 of center section frame assembly 215 and wing section frame assembly 220 and thus is not attached to any linkage (which can be referred to as a center position configuration). More specifically, when actuator 214 is in the retracted position 342 (FIG. 3), the pivot pins at the distal ends of second segments 232, 235 of first and second links 227, 228 (associated with actuator 214) are distanced from each other a shorter distance than the distance between the pivot pins of respective pivot connectors 219, 224 at first and second pivot portions 233, 236. On the other hand, when actuator 214 is in the extended position 443 (FIG. 4), the pivot pins at the distal ends of second segments 232, 235 of first and second links 227, 228 are distanced from each other a longer distance than distance between the pivot pins of respective pivot connectors 219, 224 at first and second pivot portions 233, 236. In this way, the embodiment of the present invention shown in FIGS. 2-4 provide more mechanical advantage than the center position configuration and is advantageous in being able to control positioning of wing section frame assembly 220 (in particular the outboard end of wing section frame assembly 220, which experiences the greatest distance of travel between the retracted and extended positions 342, 443 of actuator 214 relative to an inboard end of wing section frame assembly 220); for, the stroke of hydraulic cylinder assembly 214 is increased relative to the center position configuration, resulting in finer control of wing section frame assembly 220 and less force.

Further, hydraulic cylinder assembly 214 can be controlled by a control system (not shown) of combine 100 including header 110, such controlling of hydraulic cylinder assembly 214 resulting in fine control of the positioning of wing section frame assembly 220 relative to center section frame assembly 215. As a part of the control system, hydraulic cylinder assemblies 214 can be used to automatically position the wing section frame assembly 220 relative to the terrain that combine 100 is traversing. In addition thereto, hydraulic cylinder assemblies 214 can be used by operator of combine 100 to selectively raise and lower wing section frame assemblies 220 when so desired. With regard to automatic positioning of the wing section frame assemblies 220 by way of the control system, header 110 may experience uneven terrain across its transverse extent, such that a wing section 107 may encounter lower or higher ground relative to center section 106. In order to maintain an even cutting height of the crop material, it is desired to be able to raise or lower a respective wing section 107 accordingly, and thereby to adjust the height of wing sections 107 in accordance with a desired height above the ground. To accomplish this, sensors can be positioned on the wing sections 107, for instance, to sense the height of the respective wing section 107 above the ground, and this sensed height can be sent to a controller of combine 100. To the extent that this actual height does not match the desired height, the controller, by way of associated processor(s), memory, data, instructions, and any output modules, can output a signal to flow valves associated with respective hydraulic cylinder assemblies 214 in order to adjust the height of a respective wing section 107 by way of respective hydraulic cylinder assemblies 214, the flow valves inputting and outputting the proper amount of hydraulic oil into and out of the cylinder of a respective hydraulic cylinder assembly 214.

In use, operator can choose to raise or lower wing sections 107 by way of actuators 214, or the control system can automatically do so. Either way, when actuator 214 receives an inflow of hydraulic fluid, the rod of actuator 214 moves towards the extended position 443. When this happens, as shown by comparing FIGS. 3 and 4, wing section frame assembly 220 is lowered. Conversely, when actuator 214 outputs hydraulic fluid, the rod of actuator 214 moves toward the retracted position 443, with the result that wing section frame assembly 220 is raised. In this way, actuator 214 can move wing section frame assembly 220 proportionally between the extremes of the down-most and up-most positions.

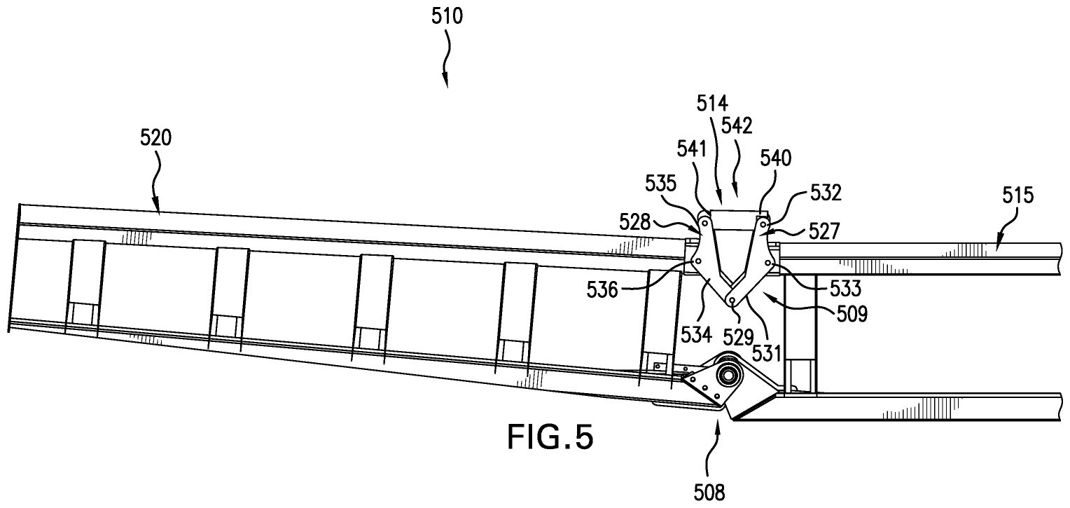

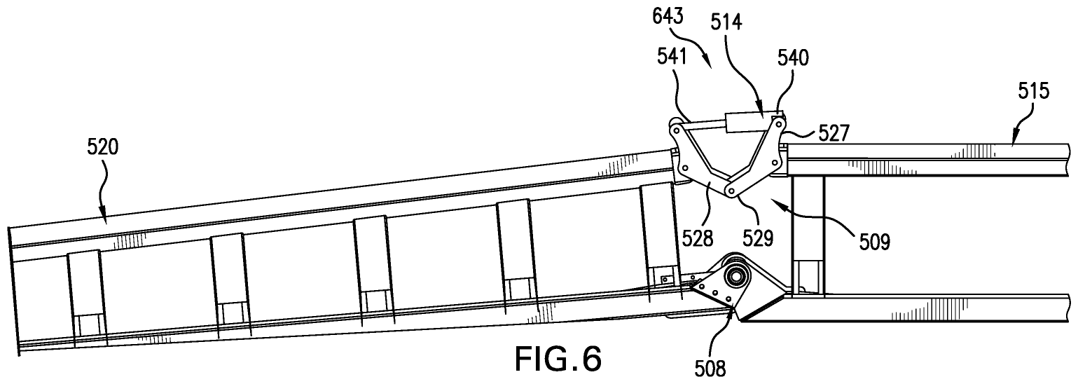

Referring now to FIGS. 5-6, there is shown an alternative exemplary embodiment of the present invention. Corresponding reference numbers are raised by a multiple of 100. Because the components are substantially similar to what is described and shown above relative to the embodiment of FIGS. 2-4, such components will not be described again in detail, as what is said and shown above applies to this embodiment as well, unless stated otherwise. FIGS. 5-6 show a portion of a header 510 of combine 100 (header 510 being substituted for header 110 of combine 100). Header 510 includes a center section frame assembly 515, a wing section frame assembly 520, a hinge 508, a TTL assembly 509, and a fluid actuator 514 (formed as a hydraulic cylinder assembly). TTL assembly 509 includes a first link 527 including a first segment 531 and a second segment 532, a second link 528 including a first segment 534 and a second segment 535, and a first pivot connection 529 pivotably connecting first link 527 and second link 528 together. First and second segment 531, 532 of first link 527 are rigidly connected to one another and form a first pivot portion 533 therebetween. First and second segment 534, 535 of second link 528 are rigidly connected to one another and form a second pivot portion 536 therebetween. First segment 531 of first link 527 forms first pivot connection 529 with first segment 534 of second link 528. First link 527 is pivotably connected with the center section frame assembly 515 or wing section frame assembly 520, FIG. 5 showing that first link 527 is pivotably connected with center section frame assembly 515 at first pivot portion 533. Second link 528 is pivotably connected with center section frame assembly 515 or wing section frame assembly 520, FIG. 5 showing that second link 528 is pivotably connected with wing section frame assembly 520 at second pivot portion 536. Hydraulic cylinder assembly 514 is pivotably connected to second segment 532 of first link 527 and is thereby configured for positioning wing section frame assembly 520 relative to center section frame assembly 515. More specifically, hydraulic cylinder assembly 514 includes a first end 540 and a second end 541, first end 540 being pivotably connected to second segment 531 of first link 527, second end 541 being pivotably connected to second segment 535 of second link 528. The primary difference between the embodiment of the present invention shown in FIGS. 2-4 and the embodiment of the present invention shown in FIGS. 5-6 is the positioning of first and second links 527, 528, as well as actuator 514. That is, the position of these structures is reversed in a down-to-up direction. This is readily visible, in particular, with respect to actuator 514, which is positioned above first pivot position 529 in FIG. 5. In use, at the command of the operator or automatically by way of the control system, actuator 514 can move wing section frame assembly 520 proportionally between an up-most position (when actuator is in a retracted position 542, as shown in FIG. 5) and a down-most position (when actuator is in an extended position 643, as shown in FIG. 6).

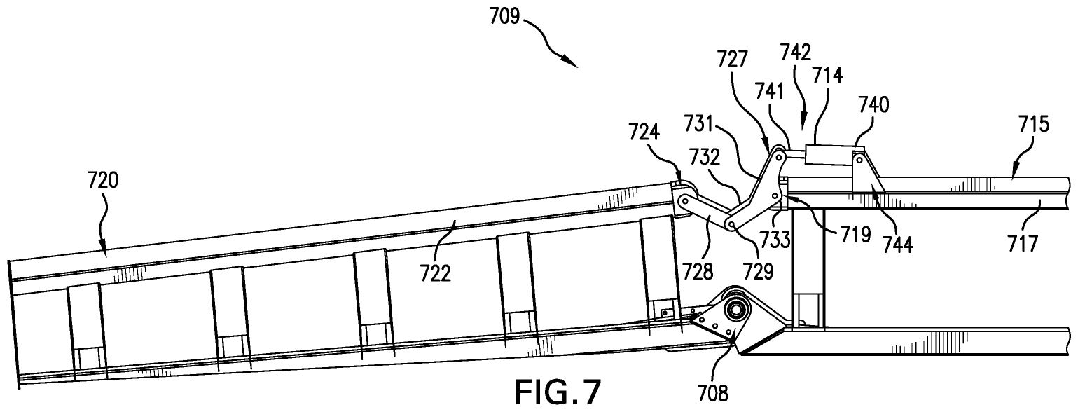

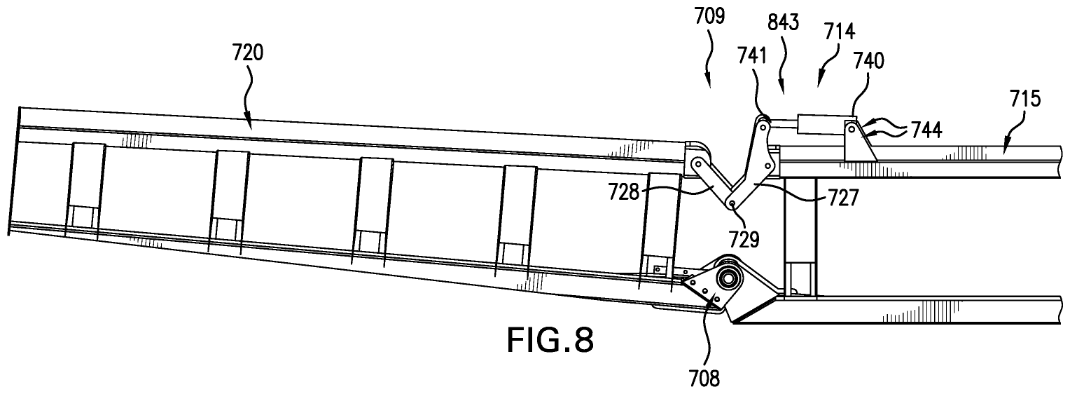

Referring now to FIGS. 7-8, there is shown an alternative exemplary embodiment of the present invention. Corresponding reference numbers are raised by a multiple of 100. Because the components are substantially similar to what is described and shown above relative to the embodiment of FIGS. 2-4, such components will not be described again in detail, as what is said and shown above applies to this embodiment as well, unless stated otherwise. FIGS. 7-8 show a portion of a header 710 of combine 100 (header 710 being substituted for header 110 of combine 100). Header 710 includes a center section frame assembly 715, a wing section frame assembly 720, a hinge, a TTL assembly 709, and a fluid actuator 714 (formed as a hydraulic cylinder assembly). TTL assembly 709 includes a first link 727 including a first segment 731 and a second segment 732, a second link 728, and a first pivot connection 729 pivotably connecting first link 727 and second link 728 together. First and second segment 731, 732 of first link 727 are rigidly connected to one another and form a first pivot portion 733 therebetween. Second link 728 can be substantially straight and can include two side walls substantially parallel to one another (one such wall being clearly shown in FIG. 7) with a support (substantially similar to support 237) extending between these two side walls. First segment 731 of first link 727 forms first pivot connection 729 with second link 728. The side walls of first and second links 727, 728 can be positioned along the pivot pin of pivot connection 729 in alternating fashion moving fore-to-aft. First link 727 is pivotably connected with center section frame assembly 715 or wing section frame assembly 720, FIG. 7 showing that first link 727 is pivotably connected with center section frame assembly 715 at first pivot portion 733. The side walls of first link 727 can be positioned to the outside of the lugs of pivot connector 719 of upper frame 717 of center section frame assembly 715. Second link 728 is pivotably connected with center section frame assembly 715 or wing section frame assembly 720, FIG. 7 showing that second link 728 is pivotably connected with wing section frame assembly 720. The side walls of second link 728 can be positioned to the outside of the lugs of pivot connector 724 of the upper frame 722 of wing section frame assembly 720. Hydraulic cylinder assembly 714 is pivotably connected to second segment 732 of first link 727 and is thereby configured for positioning wing section frame assembly 720 relative to center section frame assembly 715. More specifically, hydraulic cylinder assembly 714 includes a first end 740 and a second end 741, first end 740 being pivotably connected to center section frame assembly 720, and second end 741 being pivotably connected to second segment 732 of first link 727. First end 740 of actuator 714 can be pivotably connected atop upper frame 717 of center section frame assembly 715 by way of a pivot connector 744 and a pivot pin (substantially similar to what is described above relative to, for example, pivot connectors 219), pivot connector 744 being optionally formed as upstanding lugs with through-holes to receive therethrough the pivot pin (the fore lug—seen clearly in FIG. 7—can be taller than the aft lug, given the slope of upper frame 717). In use, at the command of the operator or automatically by way of the control system, actuator 714 can move wing section frame 720 assembly proportionally between a down-most position (when actuator 714 is in a retracted position 742, as shown in FIG. 7) and an up-most position (when actuator 714 is in an extended position 843, as shown in FIG. 8).

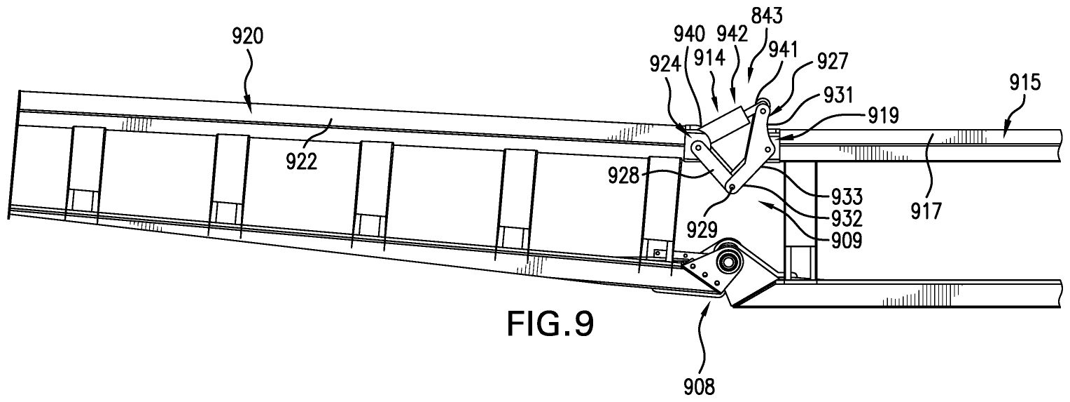

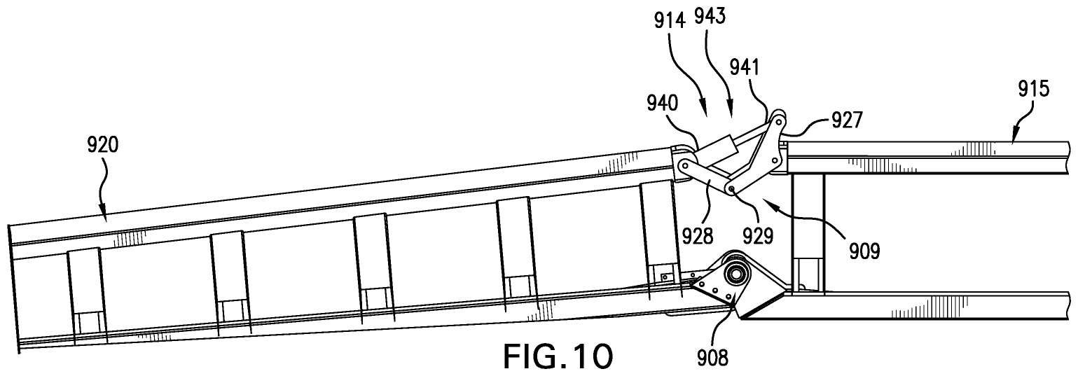

Referring now to FIGS. 9-10, there is shown an alternative exemplary embodiment of the present invention. Corresponding reference numbers are raised by a multiple of 100. Because the components are substantially similar to what is described and shown above relative to the embodiment of FIGS. 2-4, such components will not be described again in detail, as what is said and shown above applies to this embodiment as well, unless stated otherwise. FIGS. 9-10 show a portion of a header 910 of combine 100 (header 910 being substituted for header 110 of combine 100). Header 910 includes a center section frame assembly 915, a wing section frame assembly 920, a hinge 908, a TTL assembly 909, and a fluid actuator 914 (formed as a hydraulic cylinder assembly). TTL assembly 909 includes a first link 927 including a first segment 931 and a second segment 932, a second link 928, and a first pivot connection 929 pivotably connecting first link 927 and second link 928 together. First and second segment 931, 932 of first link 927 are rigidly connected to one another and form a first pivot portion 933 therebetween. Second link 928 can be substantially straight and can include two side walls substantially parallel to one another (one such wall being clearly shown in FIG. 9) with a support (substantially similar to support 237) extending between these two side walls. First segment 931 of first link 927 forms first pivot connection 929 with second link 928. The side walls of first and second links 927, 928 can be positioned along the pivot pin of pivot connection 929 in alternating fashion moving fore-to-aft. First link 927 is pivotably connected with center section frame assembly 915 or wing section frame assembly 920, FIG. 9 showing that first link 927 is pivotably connected with center section frame assembly 915 at first pivot portion 933. The side walls of first link 927 can be positioned to the outside of the pivot connector 919 of upper frame 917 of center section frame assembly 915. Second link 928 is pivotably connected with center section frame assembly 915 or wing section frame assembly 920, FIG. 9 showing that second link 928 is pivotably connected with wing section frame assembly 920. The side walls of second link 928 can be positioned to the outside of pivot connector 924 of the upper frame 922 of wing section frame assembly 920. Hydraulic cylinder assembly 914 is pivotably connected to second segment 932 of first link 927 and is thereby configured for positioning wing section frame assembly 920 relative to center section frame assembly 915. More specifically, hydraulic cylinder assembly 914 includes a first end 940 and a second end 941, first end 940 being pivotably connected to wing section frame assembly 920, and second end 941 being pivotably connected to second segment 932 of first link 927. First end 940 of actuator 914 can be pivotably connected to pivot connector 924 of wing section frame assembly 920, which is also used by second link 928. In this way first end 940 of actuator 914 and second link 928 share pivot connector 924 and the associated pivot pin. In use, at the command of the operator or automatically by way of the control system, actuator 914 can move wing section frame assembly 920 proportionally between an up-most position (when actuator is in a retracted position 942, as shown in FIG. 9) and a down-most position (when actuator 914 is in an extended position 1043, as shown in FIG. 10).

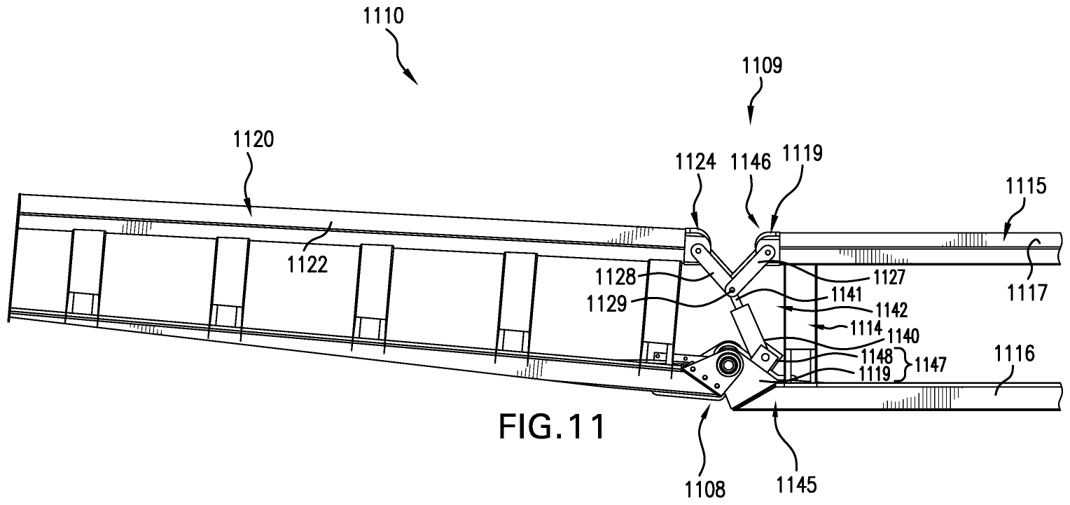

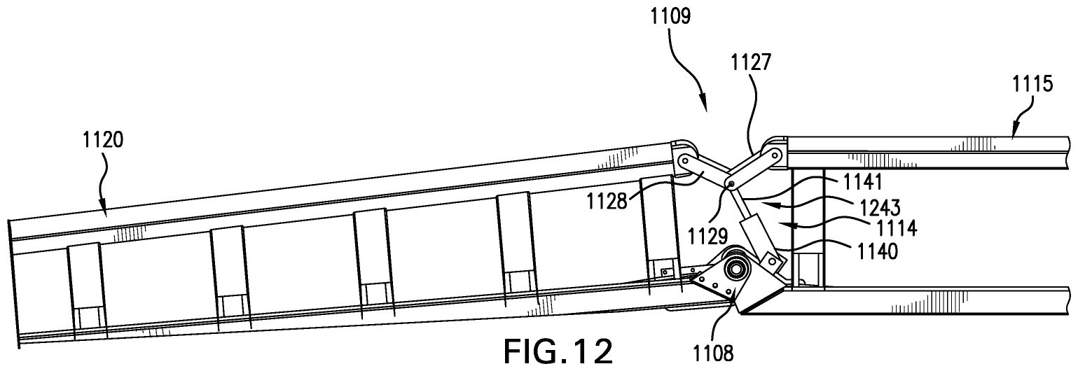

Referring now to FIGS. 11-12, there is shown an alternative exemplary embodiment of the present invention. Corresponding reference numbers are raised by a multiple of 100. Because the components are substantially similar to what is described and shown above relative to the embodiment of FIGS. 2-4, such components will not be described again in detail, as what is said and shown above applies to this embodiment as well, unless stated otherwise. FIGS. 11-12 show a portion of a header 1110 of combine 100 (header 1110 being substituted for header 110 of combine 100). Header 1110 includes a center section frame assembly 1115, a wing section frame assembly 1120, a hinge 1108, a TTL assembly 1109, and a fluid actuator 1114 (formed as a hydraulic cylinder assembly). TTL assembly 1109 includes a first link 1127, a second link 1128, and a first pivot connection 1109 pivotably connecting first link 1127 and second link 1128 together. First and second links 1127, 1128 can each be substantially straight and can include two side walls substantially parallel to one another (one such wall of each being clearly shown in FIG. 11) with a support (substantially similar to support 237) extending between these two side walls. The side walls of first and second links 1127, 1128 can extend along the pivot pin of first pivot connection 1129 in alternating fashion moving fore-to-aft. First link 1127 is pivotably connected to center section frame assembly 1115. Second link 1128 is pivotably connected to wing section frame assembly 1120. The side walls of first link 1127 can be positioned to the outside of the pivot connector 1119 of upper frame 1117 of center section frame assembly 1115. The side walls of second link 1128 can be positioned to the outside of pivot connector 1124 of the upper frame 1122 of wing section frame assembly 1120. Header 1110 can further include a second pivot connection 1145 and a third pivot connection 1146. Hydraulic cylinder assembly 1114 is configured for positioning wing section frame assembly 1120 relative to center section frame assembly 1115. Actuator 1114 includes a first end 1140 and a second end 1141. First end 1140 is pivotably connected to center section frame assembly 1115 or wing section frame assembly 1120, FIG. 11 showing that first end 114 is pivotably connected to center section frame assembly 1115. Further, first end 1140 is spaced apart from both first link 1127 and second link 1128. Second end 1141 is pivotably connected to first pivot connection 1129. First end 1140 of actuator 1114 is pivotably connected to center section frame assembly 1115 at second pivot connection 1145. First link 1127 is pivotably connected to center section frame assembly 1115 at third pivot connection 1146, which is positioned above second pivot connection 1145. More specifically, referencing the description above relative to FIGS. 2-4, center section frame assembly 1115 includes a lower frame 1116 and an upper frame 1117, wherein second pivot connection 1145 is associated with lower frame 1116, and third pivot connection 1146 is associated with upper frame 1145. Each of second and third pivot connections 1145, 1146 includes a respective pivot connector assembly 1147 and pivot connector 1119, as well as a pivot pin, about which respective ones of first end 1140 of actuator 1114 and first link 1127 pivots. Each of pivot connector 1119 and pivot connector assembly 1147 can include two opposing lugs or tabs, each of which includes a through-hole for receiving the pivot pin. The pivot connector 1119 of third pivot connection 1146 is substantially similar to pivot connector 219 in FIG. 2. The pivot connector assembly 1147 of second pivot connection 1145 can include the pivot connector 1119 of lower frame 1116 of center section frame assembly 1115 as shown in FIG. 2 (which forms a part of hinge 1108), together with upstanding opposing tabs 1148 mounted to pivot connector 1119, tabs 1148 for holding the pivot pin. Each of second and third pivot connections 1145, 1146 can further include any suitable securing mechanism for securing the pivot pin, such as cotter pins, weldments, bearings, sleeves, or the like. In use, at the command of the operator or automatically by way of the control system, actuator 1114 can move wing section frame assembly 1120 proportionally between an up-most position (when actuator is in a retracted position 1142, as shown in FIG. 11) and a down-most position (when actuator is in an extended position 1243, as shown in FIG. 12).

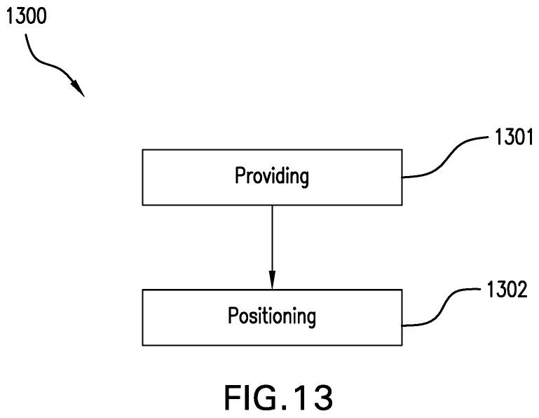

Referring now to FIG. 13, there is shown a flow diagram of a method 1300 of using an agricultural vehicle 1000 including an agricultural work assembly 110, 510, 710, 910. Method 1300 includes the steps of: providing 1301 an agricultural work assembly 110, 510, 710, 910 including: a center section frame assembly 215, 515, 715, 915; a wing section frame assembly 220, 520, 720, 920; a linkage assembly 209, 509, 709, 909 including a first link 227, 527, 727, 927, a second link 228, 528, 728, 928, and a pivot connection 229, 529, 729, 929 pivotably connecting the first link 227, 527, 727, 927 and the second link 228, 528, 728, 928 together, the first link 227, 527, 727, 927 including a first segment 231, 531, 731, 931 and a second segment 232, 532, 732, 932 rigidly connected to one another and forming a pivot portion 233, 533, 733, 933 therebetween, the first segment 231, 531, 731, 931 forming the pivot connection 229, 529, 729, 929 with the second link 228, 528, 728, 928, the first link 227, 527, 727, 927 being pivotably connected to one of the center section frame assembly 215, 515, 715, 915 and the wing section frame assembly 220, 520, 720, 920 at the pivot portion 233, 533, 733, 933, the second link 228, 528, 728, 928 being pivotably connected to the other one of, relative to the first link 227, 527, 727, 827, the center section frame assembly 215, 515, 715, 915 and the wing section frame assembly 220, 520, 720, 920; and an actuator 214, 514, 714, 914 pivotably connected to the second segment 232, 532, 732, 932; and positioning 1302, using the actuator 214, 514, 714, 914 and by way of the actuator 214, 514, 714, 914 being pivotably connected to the second segment 232, 532, 732, 932, the wing section frame assembly 220, 520, 720, 920 relative to the center section frame assembly 215, 515, 715, 915. Further, the pivot portion is a first pivot portion 233, 533, the first link 227, 527 being pivotably connect to the center section frame assembly 215, 515, the second link 228, 528 including a first segment 234, 534 and a second segment 235, 535 rigidly connected to one another and forming a second pivot portion 236, 536 therebetween, the second link 228, 528 being pivotably connected to the wing section frame assembly 220, 520 at the second pivot portion 236, 536, the first segment 231, 531 of the first link 227, 527 and the first segment 234, 534 of the second link 228, 528 forming the first pivot connection 229, 529, the actuator 214, 514 including a first end 240, 540 and a second end 241, 541, the first end 240, 540 being pivotably connected to the second segment 232, 532 of the first link 227, 527, the second end 241, 541 being pivotably connected to the second segment 235, 535 of the second link 228, 528. Further, the actuator 214 can positioned below the pivot connection 229. Alternatively, the actuator 514 can be positioned above the pivot connection 529. Alternatively, the first link 727 can be pivotably connected to the center section frame assembly 715 and the second link 728 can be pivotably connected to the wing section frame assembly 720, the actuator 714 including a first end 740 and a second end 741, the first end 740 being pivotably connected to the center section frame assembly 715, the second end 741 being pivotably connected to the second segment 732. Alternatively, the first link 927 can be pivotably connected to the center section frame assembly 915 and the second link 928 can be pivotably connected to the wing section frame assembly 920, the actuator 914 including a first end 940 and a second end 941, the first end 940 being pivotably connected the wing section 920, the second end 941 being pivotably connected to the second segment 932.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. An agricultural work assembly of an agricultural vehicle, the work assembly comprising:
a center section frame assembly;
a wing section frame assembly;
a linkage assembly including a first link, a second link, and a pivot connection pivotably connecting the first link and the second link together, the first link including a first segment and a second segment rigidly connected to one another and forming a pivot portion therebetween, the first segment forming the pivot connection with the second link, the first link being pivotably connected to one of the center section frame assembly and the wing section frame assembly at the pivot portion, the second link being pivotably connected to the other one of, relative to the first link, the center section frame assembly and the wing section frame assembly; and
an actuator pivotably connected to the second segment and thereby configured for positioning the wing section frame assembly relative to the center section frame assembly.

2. The agricultural work assembly of claim 1, wherein the pivot portion is a first pivot portion, the first link being pivotably connect to the center section frame assembly, the second link including a first segment and a second segment rigidly connected to one another and forming a second pivot portion therebetween, the second link being pivotably connected to the wing section frame assembly at the second pivot portion, the first segment of the first link and the first segment of the second link forming the first pivot connection, the actuator including a first end and a second end, the first end being pivotably connected to the second segment of the first link, the second end being pivotably connected to the second segment of the second link.

3. The agricultural work assembly of claim 2, wherein the actuator is positioned below the pivot connection.

4. The agricultural work assembly of claim 2, wherein the actuator is positioned above the pivot connection.

5. The agricultural work assembly of claim 1, wherein the first link is pivotably connected to the center section frame assembly and the second link is pivotably connected to the wing section frame assembly, the actuator including a first end and a second end, the first end being pivotably connected to the center section frame assembly, the second end being pivotably connected to the second segment.

6. The agricultural work assembly of claim 1, wherein the first link is pivotably connected to the center section frame assembly and the second link is pivotably connected to the wing section frame assembly, the actuator including a first end and a second end, the first end being pivotably connected the wing section, the second end being pivotably connected to the second segment.

7. An agricultural work assembly of an agricultural vehicle, the work assembly comprising:
a center section frame assembly;
a wing section frame assembly;
a linkage assembly including a first link, a second link, and a pivot connection pivotably connecting the first link and the second link together, the first link and the second link being pivotably connected respectively to the center section frame assembly and the wing section frame assembly; and
an actuator configured for positioning the wing section frame assembly relative to the center section frame assembly, the actuator including a first end and a second end, the first end being pivotably connected to one of the center section frame assembly and the wing section frame assembly and spaced apart from both the first link and second link, the second end being pivotably connected to the pivot connection.

8. The agricultural work assembly of claim 7, wherein the pivot connection is a first pivot connection, the agricultural work assembly further including a second pivot connection, the first end of the actuator being pivotably connected to the center section frame assembly at the second pivot connection.

9. The agricultural work assembly of claim 8, further including a third pivot connection, wherein the first link is pivotably connected to the center section frame assembly at the third pivot connection which is positioned above the second pivot connection.

10. The agricultural work assembly of claim 9, wherein the center section frame assembly includes an upper frame and a lower frame, the second pivot connection being associated with the lower frame, the third pivot connection being associated with the upper frame.

11. A method of using an agricultural vehicle including an agricultural work assembly, the method including the steps of:
harvesting crop using an agricultural work assembly including:
a center section frame assembly;
a wing section frame assembly;
a linkage assembly including a first link, a second link, and a pivot connection pivotably connecting the first link and the second link together, the first link including a first segment and a second segment rigidly connected to one another and forming a pivot portion therebetween, the first segment forming the pivot connection with the second link, the first link being pivotably connected to one of the center section frame assembly and the wing section frame assembly at the pivot portion, the second link being pivotably connected to the other one of, relative to the first link, the center section frame assembly and the wing section frame assembly; and
an actuator pivotably connected to the second segment; and
positioning, using the actuator and by way of the actuator being pivotably connected to the second segment, the wing section frame assembly relative to the center section frame assembly.

12. The method of claim 11, wherein the pivot portion is a first pivot portion, the first link being pivotably connect to the center section frame assembly, the second link including a first segment and a second segment rigidly connected to one another and forming a second pivot portion therebetween, the second link being pivotably connected to the wing section frame assembly at the second pivot portion, the first segment of the first link and the first segment of the second link forming the first pivot connection, the actuator including a first end and a second end, the first end being pivotably connected to the second segment of the first link, the second end being pivotably connected to the second segment of the second link.

13. The method of claim 12, wherein the actuator is positioned below the pivot connection.

14. The method of claim 12, wherein the actuator is positioned above the pivot connection.

15. The method of claim 11, wherein the first link is pivotably connected to the center section frame assembly and the second link is pivotably connected to the wing section frame assembly, the actuator including a first end and a second end, the first end being pivotably connected to the center section frame assembly, the second end being pivotably connected to the second segment.

16. The method of claim 11, wherein the first link is pivotably connected to the center section frame assembly and the second link is pivotably connected to the wing section frame assembly, the actuator including a first end and a second end, the first end being pivotably connected the wing section, the second end being pivotably connected to the second segment.
